(19) United States
(12) Patent Application Publication
(10) Pub. No.: US 2012/0127436 A1
(43) Pub. Date: May 24, 2012

(54) ILLUMINATION MODULE AND PROJECTION APPARATUS

(75) Inventor: Chiang-Yang Fang, Taichung City (TW)

(73) Assignees: WINTEK CORPORATION, Taichung City (TW); WINTEK TECHNOLOGY DONGGUAN LTD., Guangdong Province (CN)

(21) Appl. No.: 13/299,364

(22) Filed: Nov. 18, 2011

(30) Foreign Application Priority Data
Nov. 19, 2010 (TW) 99140014

(51) Int. Cl. G03B 21/28; F21V 13/00

(52) U.S. Cl. 353/20; 362/19

(57) ABSTRACT

A projection apparatus including an illumination module, a display panel, and a projection lens module is provided. The illumination module includes a light source assembly including a light guide plate, a light source, a reflector, and a reflective polarizer, and a polarized beam splitter (PBS). The light guide plate has a light emitting surface, a bottom surface opposite to the light emitting surface, and a light incident surface connected between the light emitting surface and the bottom surface. The light source, the reflector, and the reflective polarizer are faced to the light incident surface, the bottom surface, and the light emitting surface respectively. The PBS is disposed beside the reflective polarizer away from the light guide plate. The display panel and the light source assembly are respectively located at two adjacent sides of the PBS. The projection lens module is disposed beside the PBS away from the display panel.

### CROSS-REFERENCE TO RELATED APPLICATION

This application claims the priority benefit of Taiwan application serial no. 99140014, filed on Nov. 19, 2010. The entirety of the above-mentioned patent application is hereby incorporated by reference herein and made a part of this specification.

### BACKGROUND OF THE INVENTION

1. Field of the Invention

The invention relates to an illumination module and a projection apparatus and more particularly to an illumination module of a projection apparatus and a projection apparatus.

2. Description of Related Art

Pico projection technology actualizes portable projection apparatuses with light weight and compact volume. Pico projection technology is mainly categorized into pico projection apparatus technology and pocket projection apparatus. Herein, pocket projection apparatus is similar to, but lighter and more compact than the traditional projection apparatus, and is convenient for the user to carry around. On the other hand, pico projection apparatus is even lighter and can be integrated in portable products such as mobile phones, digital cameras, and the like.

The pico projection technology currently adopted in the pico projection apparatus mainly includes liquid crystal display (LCD) technology, digital light processing (DLP) technology, liquid crystal on silicon (LCOS) technology, micro electro mechanical systems (MEMs) microscanners, and so on.

The light source of the pico projection apparatus includes the RGB light emitting diode (LED), the white LED, or the laser. In pico projection technology, the light emitted by the light source is first split by a polarized beam splitter (PBS) and then projected onto the screen for showing the image. However, limited to the use of the PBS, only the light with specific polarization characteristic can be used among the light emitted by the light source, such that the light utilization rate of the light source can not be increased.

### SUMMARY OF THE INVENTION

The invention is direction to an illumination module adopted in a projection apparatus for increasing light utilization rate.

The invention is directed to a projection apparatus having favorable light utilization rate.

The invention is directed to an illumination module used in a projection apparatus. The illumination module includes a light source assembly and a polarized beam splitter (PBS). The light source assembly includes a light guide plate, a light source, a reflector, and a reflective polarizer. The light guide plate has a light emitting surface, a bottom surface, and a light incident surface. The light emitting surface is opposite to the bottom surface and the light incident surface is connected between the light emitting surface and the bottom surface. The light source is disposed beside the light guide plate and faces the light incident surface. The reflector faces the bottom surface of the light guide plate. The reflective polarizer faces the light emitting surface of the light guide plate. The PBS is disposed beside the reflective polarizer away from the light guide plate.

The invention is further directed to a projection apparatus including the illumination module aforementioned, a display panel, and a projection lens module. The display panel faces the PBS. The display panel and the light source assembly are disposed on respective sides of the PBS. The projection lens module is disposed beside the PBS away from the display panel.

In light of the foregoing, a combination of the reflective polarizer and the reflector is applied in the illumination module of the invention. Accordingly, a light emitted by the light source can be converted to a light having a specific polarization characteristic through the reflective polarizer and the reflector to increase the light utilization rate of the projection apparatus.

In order to make the aforementioned and other features and advantages of the invention more comprehensible, several embodiments accompanied with figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 illustrates a schematic view of a projection apparatus according to an embodiment of the invention.

FIG. 2 illustrates a schematic view of a projection apparatus according to another embodiment of the invention.

FIG. 3 illustrates a schematic view of a light source assembly in a projection apparatus according to an embodiment of the invention.

FIG. 4 illustrates a schematic view of another light source assembly in a projection apparatus according to an embodiment of the invention.

FIG. 5 illustrates a schematic view of further another light source assembly in a projection apparatus according to an embodiment of the invention.

FIG. 6 illustrates a schematic view of still another light source assembly in a projection apparatus according to an embodiment of the invention.

### DESCRIPTION OF EMBODIMENTS

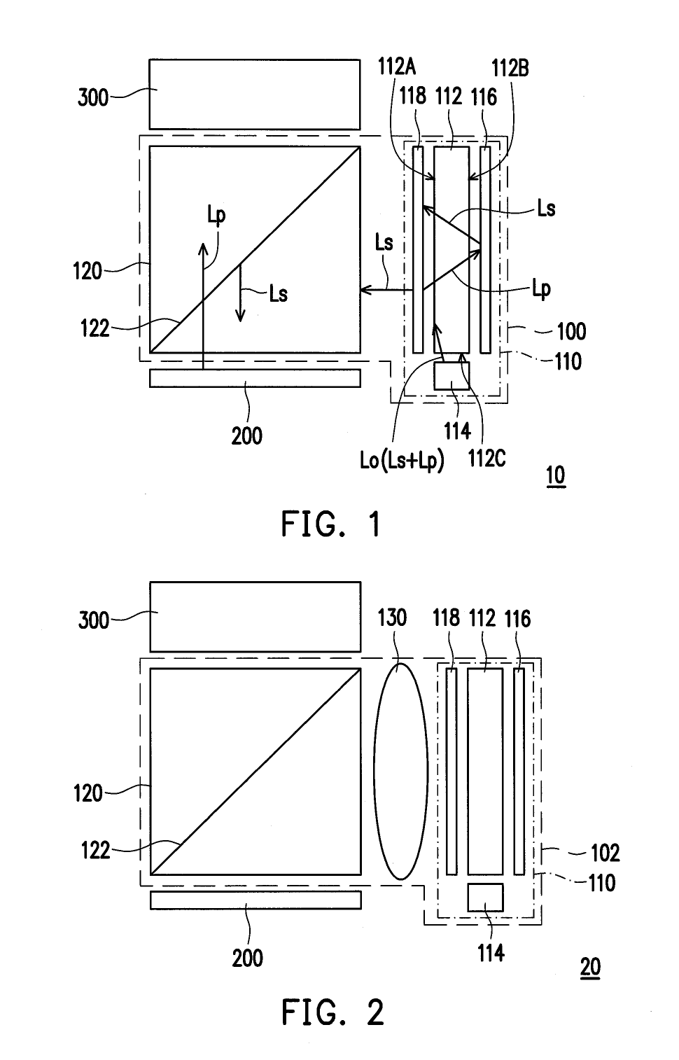

FIG. 1 illustrates a schematic view of a projection apparatus according to an embodiment of the invention. Referring to FIG. 1, a projection apparatus 10 includes an illumination module 100, a display panel 200, and a projection lens module 300. The display panel 200 and the projection lens module 300 are disposed on respective sides of the illumination module 100. In the present embodiment, the display panel 200 is, for example, a reflective display panel (i.e. a liquid crystal on silicon (LCOS) display panel) and the projection lens module 300 can include a plurality of lenses. Persons skilled in the art should understand that the projection lens module 300 is adopted to project a display light emitted by the display panel 200 to an external screen so as to display an image on the screen. The present embodiment does not particularly limit the design of the projection lens module 300.

Specifically, the illumination module 100 includes a light source assembly 110 and a polarized beam splitter (PBS) 120. The light source assembly 110 includes a light guide plate 112, a light source 114, a reflector 116, and a reflective polarizer 118. The light guide plate 112 has a light emitting surface 112A, a bottom surface 112B, and a light incident surface 112C. The light emitting surface 112A is opposite to the bottom surface 112B and the light incident surface 112C is connected between the light emitting surface 112A and the bottom surface 112B. The light source 114 is disposed beside the light guide plate 112 and faces the light incident surface 112C. The reflector 116 faces the bottom surface 112B of the light guide plate 112. The reflective polarizer 118 faces the light emitting surface 112A of the light guide plate 112. In other words, the light guide plate 112 is designed to be a lateral incident type light guide plate. The PBS 120 is disposed beside the reflective polarizer 118 away from the light guide plate 112. Moreover, in the projection apparatus 10, the display panel 200 and the light source assembly 110 are disposed on respective sides of the PBS 120.

In the present embodiment, the PBS 120 has, for instance, a multilayer film 122 for the light to penetrate or reflect according to a polarization characteristic of the light. For example, characteristics of the multilayer film 122 includes reflecting a light Ls in a S-type polarization state and allowing a light Lp in a P-type polarization state to penetrate. The display panel 200 is generally a reflective display panel. Moreover, the light Ls reflected by the multilayer film 122 enters the display panel 200 through a disposition of the multilayer film 122 and the display panel 200. That is, the light entering the display panel 200 is the light Ls in the S-type polarization state. The light Ls in the S-type polarization state can be converted into the light Lp in the P-type polarization state through the reflection of the display panel 200 and then emitted toward the PBS 120. The light Lp in the P-type polarization state, that is, the display light, can penetrate the multilayer film 122 of the PBS 120 directly and enter the projection lens module 300 so as to be projected.

Accordingly, when the light of the light source 114 entering the PBS 120 is the light Ls in the S-type polarization state, the light can be projected for display after passing through the PBS 120. Nevertheless, the light source 114 is, for example, a light emitting diode (LED) light source. A light Lo emitted by the light source 114 includes the light Ls in the S-type polarization state and the light Lp in the P-type polarization state, and thus does not have a specific polarization characteristic. As a consequence, the light Lo emitted by the light source 114 can not be utilized completely. Therefore, the reflector 116 and the reflective polarizer 118 are disposed in the light source assembly 110 of the present embodiment to increase the light utilization rate.

In details, the reflective polarizer 118 allows the light in a specific polarization state to penetrate through and reflects the remaining light. For example, in the present embodiment, the light Ls in the S-type polarization state penetrates the reflective polarizer 118 and the light Lp in the P-type polarization state is reflected by the reflective polarizer 118. Therefore, a portion of the light Lo (i.e. the light Ls in the S-type polarization state) emitted by the light source 114 penetrates the reflective polarizer 118 directly and another portion of the light Lo (i.e. the light Lp in the P-type polarization state) is reflected back to the light guide plate 112. The portion penetrating the reflective polarizer 118 directly can be reflected by the PBS 120, thereby entering the display panel 200. Afterwards, the portion penetrating the reflective polarizer 118 is converted into the light Lp in the P-type polarization state while being reflected by the display panel 200. The light Lp in the P-type polarization state is then projected. This portion of the light Lo (i.e. the light Ls in the S-type polarization state) can thus be utilized effectively.

On the other hand, after irradiating the reflector 116, the light Lp in the P-type polarization state reflected by the reflective polarizer 118 is again reflected by the reflector 116 to emit toward the reflective polarizer 118. After penetrating the light guide plate 112 and being reflected by the reflector 116 repetitively, the polarization characteristic of the light is altered such that the light is at least partially converted to the light Ls in the S-type polarization state. At this time, the light Ls in the S-type polarization state can penetrate the reflective polarizer 118 and then enter the PBS 120 to be utilized. That is, in the light Lo emitted by the light source 114, the light Lp in the P-type polarization state can be converted to the utilizable light Ls in the S-type polarization state through the reflective polarizer 118 and the reflector 116. Hence, the light utilization rate of the illumination module 100 can be greatly increased.

In the present embodiment, the co-operation of the reflective polarizer 118 and the reflector 116 allows the conversion of light polarization states. Therefore, though light Lo emitted by the light source 114 misses specific polarization characteristic, the light Lo can be emitted from the reflective polarizer 118 with the required polarization characteristic through the conversion of light polarization states. Accordingly, a high light utilization rate is attained. However, the invention is not limited to the embodiment aforementioned. In other embodiments, the illumination module 100 further includes other optical components to enhance the light utilization rate of the projection apparatus 10.

FIG. 2 illustrates a schematic view of a projection apparatus according to another embodiment of the invention. Referring to FIG. 2, other than all of the components in the projection apparatus 10, an illumination module 102 in a projection apparatus 20 further includes a collimating element 130 disposed between the PBS 120 and the reflective polarizer 118 of the light source assembly 110. In other words, the components identical in FIGS. 2 and 1 are denoted with the same notations. In the present embodiment, the light emitted by the light source assembly 110 is collimated and enters the PBS 120 through the disposition of the collimating element 130. For example, the collimating element 130 includes at least one lens, which can be a convex lens, a concave lens, a concave-convex lens, or a combination of various lens. Accordingly, the collimated light entering the PBS 120 can enter the display panel 200 with the required beam angle to increase the light utilization rate of the projection apparatus 20.

It should be noted that in the traditional projection apparatus, the light emitted by the LED light source enters the PBS directly. Herein, a portion of the light penetrates the PBS directly and is not reflected to the display panel. Therefore, when comparing to that of the traditional projection apparatus, the light utilization rate of the projection apparatus 20 can increase at least 35%. For instance, when the LED light source having an illumination intensity of 100 lumen (lm) is adopted as the light source, the highest illumination intensity projected by the traditional projection apparatus is about 40 μm and the highest illumination intensity projected by the projection apparatus 20 is about 54 μm.

Obviously, the invention is not limited to adopting the collimating element 130 for actualizing the collimation of light. In other embodiments, the light source assembly 110 includes suitable optical elements, so that the light provided by the light source assembly 110 is collimated and irradiates the PBS 120. Additionally, the light source assembly 110 can provide more favorable light utilization rate and emission effect through the disposition of other optical components.

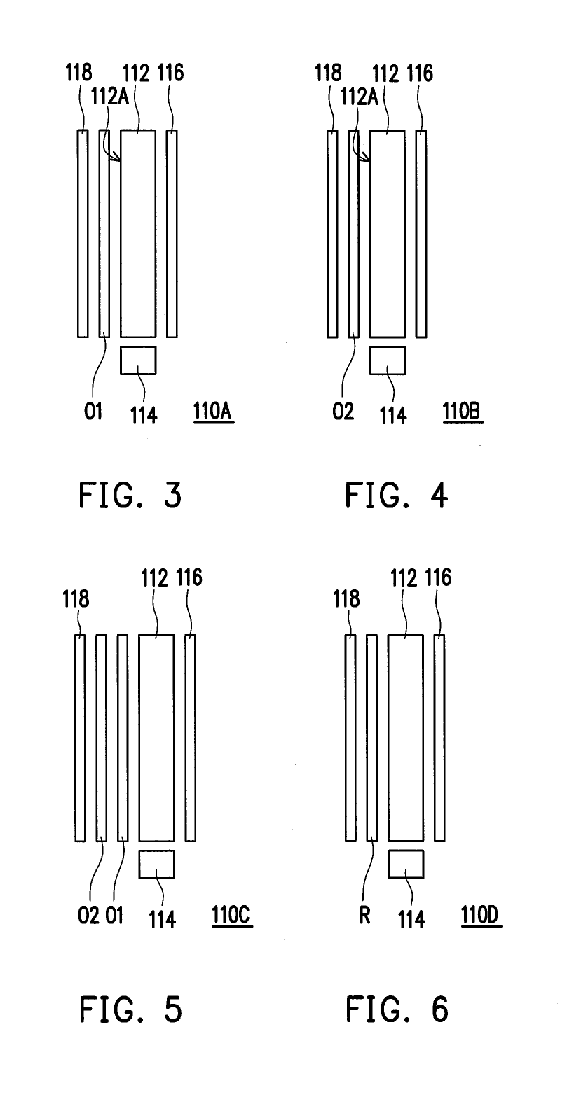

For instance, FIG. 3 illustrates a schematic view of a light source assembly in a projection apparatus according to an embodiment of the invention. Referring to FIG. 3, a light source assembly 110A includes the light guide plate 112, the light source 114, the reflector 116, and the reflective polarizer 118. Moreover, the light source module 110A further includes a diffuser O1 disposed beside the light guide plate 112 away from the reflector 116 and located between the light emitting surface 112A and the reflective polarizer 118. The disposition of the diffuser O1 facilitates in enhancing the emitting uniformity of the light source assembly 110A. Thus, the display quality of the components is enhanced overall when the light source module 110A is utilized in the projection apparatus 10 or the projection apparatus 20.

Further, FIG. 4 illustrates a schematic view of another light source assembly in a projection apparatus according to an embodiment of the invention. Referring to FIG. 4, a light source assembly 110B includes the light guide plate 112, the light source 114, the reflector 116, and the reflective polarizer 118. Moreover, the light source module 110B further includes a brightness enhancement film O2 disposed beside the light guide plate 112 away from the reflector 116 and located between the light emitting surface 112A and the reflective polarizer 118. The brightness enhancement film O2 is, for example, a prism sheet and the disposition thereof facilitates in enhancing the emitting intensity of the light source assembly 110B. In other embodiments, two brightness enhancement films O2 can be disposed between the light emitting surface 112A and the reflective polarizer 118. The prism directions of the brightness enhancement films O2 cross each other to provide the favorable emission effect.

The diffuser O1 in FIG. 3 and the brightness enhancement film O2 in FIG. 4 can be used in the light source assembly simultaneously as shown in FIG. 5. FIG. 5 illustrates a schematic view of further another light source assembly in a projection apparatus according to an embodiment of the invention. Referring to FIG. 5, a light source assembly 110C includes the light guide plate 112, the light source 114, the reflector 116, and the reflective polarizer 118. The light source assembly 110C further includes the diffuser O1 and the brightness enhancement film O2. The diffuser O1 and the brightness enhancement film O2 is disposed between the light emitting surface 112A of the light guide plate 112 and the reflective polarizer 118.

In the present embodiment, the diffuser O1 is disposed between the brightness enhancement film O2 and the light guide plate 112. Nevertheless, in other embodiments, the placement of the diffuser O1 and the brightness enhancement film O2 can be reversed so that the enhancement film O2 is disposed between the diffuser O1 and the light guide plate 112. Conversely, the diffuser O1 and the brightness enhancement film O2 can be selectively disposed beside the reflective polarizer 118 away from the light guide plate 112. In other words, the present embodiment does not limit the placement of the optical components (the brightness enhancement film, the diffuser, the reflective polarizer, and so on). The spirit of the invention is met as long as the reflective polarizer 118 and the reflector 116 are disposed on the respective sides of the light guide plate 112, and the disposition of the remaining optical components can be changed depending on various demands.

Further, FIG. 6 illustrates a schematic view of still another light source assembly in a projection apparatus according to an embodiment of the invention. Referring to FIG. 6, other than the light guide plate 112, the light source 114, the reflector 116, and the reflective polarizer 118, a light source assembly 110D of the present embodiment further includes a ¼ wave plate R disposed between the reflective polarizer 118 and the reflector 116 so as to convert the light reflected by the reflective polarizer 118 (i.e. the light in the P-type polarized state) into a circular polarized light having a first optical rotation direction. The circular polarized light having the first optical rotation direction is converted into a circular polarized light having a second optical rotation direction after being reflected by the reflector 116. Herein, the first optical rotation direction is on the contrary to the second optical rotation direction. At this time, the circular polarized light having the second optical rotation direction can be entirely converted into the light in the S-type polarization state after passing through the ¼ wave plate R so that the light can penetrate the reflective polarizer 118 to be utilized. Under such disposition, the light emitted by the light source 114 can be utilized more effectively to reduce energy consumption. In other embodiments, the diffuser O1 and the brightness enhancement film O2 in FIG. 5, and the ¼ wave plate R in FIG. 6 can all be disposed in the light source assembly of the invention optionally.

In summary, a plurality of optical components (for example, the light guide plate, the reflective polarizer, the reflector, and so on) is adopted in the projection apparatus of the invention, and together with the light source as the light source assembly in the illumination module, the light source assembly can provide the light with the specific polarization characteristic. Furthermore, the optical components convert the light into the light having the required polarization characteristic. The illumination module thus has the optimal light utilization rate. Accordingly, the projection apparatus can have optimal quality and energy consumption can be reduced with increase of the light utilization rate.

It will be apparent to those skilled in the art that various modifications and variations can be made to the structure of the disclosed embodiments without departing from the scope or spirit of the invention. In view of the foregoing, it is intended that the invention covers modifications and variations of this invention provided they fall within the scope of the following claims and their equivalents.

What is claimed is:

1. An illumination module adopted in a projection apparatus, the illumination module comprising:
a light source assembly, comprising:
a light guide plate having a light emitting surface, a bottom surface opposite to the light emitting surface, and a light incident surface connected between the light emitting surface and the bottom surface;
a light source disposed beside the light guide plate and facing the light incident surface;
a reflector facing the bottom surface of the light guide plate;
a reflective polarizer facing the light emitting surface of the light guide plate; and
a polarized beam splitter disposed beside the reflective polarizer away from the light guide plate.

2. The illumination module as claimed in claim 1, further comprising a collimating element disposed between the polarized beam splitter and the reflective polarizer of the light source assembly.

3. The illumination module as claimed in claim 2, wherein the collimating element comprises at least one lens.

4. The illumination module as claimed in claim 1, wherein the light source assembly further comprises a diffuser disposed beside the light guide plate away from the reflector.

5. The illumination module as claimed in claim 1, wherein the light source assembly further comprises a brightness enhancement film disposed beside the light guide plate away from the reflector.

6. The illumination module as claimed in claim 1, wherein the light source of the light source assembly is a light emitting diode light source.

7. The illumination module as claimed in claim 1, wherein the polarized beam splitter has a multilayer film for a light to penetrate or reflect according to a polarization characteristic of the light.

8. The illumination module as claimed in claim 1, wherein the light source assembly further comprises a ¼ wave plate disposed between the reflective polarizer and the reflector.

9. A projection apparatus, comprising:
the illumination module as claimed in claim 1;
a display panel facing the polarized beam splitter, wherein the display panel and the light source assembly are disposed on respective sides of the polarized beam splitter; and
a projection lens module disposed beside the polarized beam splitter away from the display panel.
